(19) United States
(12) Patent Application Publication
(10) Pub. No.: US 2014/0297490 A1
(43) Pub. Date: Oct. 2, 2014

(54) W-9 EXCHANGE SYSTEM AND METHOD

(71) Applicant: BOTTOMLINE TECHNOLOGIES (DE) INC., Portsmouth, NH (US)

(72) Inventor: Jeff HARNISCH, Hooksett, NH (US)

(73) Assignee: Bottomline Technologies (DE) Inc., Portsmouth, NH (US)

(21) Appl. No.: 13/851,309

(22) Filed: Mar. 27, 2013

(51) Int. Cl. G06Q 40/00

(52) U.S. Cl. CPC G06Q 40/123
USPC 705/31

(57) ABSTRACT

A system and method is presented for sharing tax-related information. A repository is provided for storing tax-related information corresponding to a taxpayer identification number. A user access may gain access to the repository based on a pre-determined criterion and, upon the user accessing the repository, the user is permitted to at least one of add tax-related information corresponding to taxpayer identification number to the repository, access the tax-related information stored in the repository, or change the tax-related information stored in the repository.

### TECHNICAL FIELD

The present invention relates to tax-related information and, more particularly, to a system and method for electronically sharing tax-related information stored in a repository.

### BACKGROUND OF THE INVENTION

Form W-9 (also referred to as Form W-9: Request for Taxpayer Identification Number and Certification) is an important tax form provided by the United States Internal Revenue Service (IRS) for any employer that has a business relationship with a payee, e.g., freelance workers, affiliates or other entities that are not considered an employee of the employer but receive payment from the employer. Form W-9 is used by employers to collect information to help file information returns with the IRS, and includes the name, address, and taxpayer identification information of a taxpayer (in the form of a Social Security Number or Employer Identification Number). Form W-9 is never actually provided to the IRS, but is maintained by a third party (e.g., the employer) who files an information return with the IRS for verification purposes. The information on Form W-9 and the compensation made to the payee are reported to the IRS via Form 1099-MISC.

### SUMMARY OF THE INVENTION

The process of collecting the information referenced on Form W-9 can be challenging. First, the information itself must be collected. Typically, information identified in Form W-9 information is collected prior to making payment to a non-employee payee. During the course of a business relationship, however, the payee's specific information may change. For example, the payee may move to a new home or place of business, or may undergo a name change (e.g., due to marriage or changing the business name). To accurately report any wages paid to such payee, the changes must be updated.

Presently, Form W-9 information is shared through emails or company-specific portals. Such processes, however, can inhibit timely payments to payees, and can result in inaccurate 1099 reporting (which impacts the completeness of tax revenues of the United States).

A system and method in accordance with the present invention enables Form W-9 information to be easily collected, shared and managed. According to one aspect of the invention, a repository, such as an internet-based repository in the form of a database, is provided for storing Form W-9 information or the like. The repository can support uploading and downloading of information and/or documents, as well as revising information already stored in the repository and using the stored information to populate forms.

In addition, the information stored in the repository may be shared amongst multiple departments of a business entity and/or between different business entities. Such sharing makes it simpler to obtain accurate information for payees, as the information is centrally stored and managed.

Further, access to the repository may require a membership. Members then may have access to information shared by other members. Alternatively, access to the repository may be provided as a subscription service. Under a subscription-based system, access to the repository may be granted based on payment of a fee.

Storage of the W-9 information in a central repository simplifies the searching process, thereby enabling corporate accounts receivable and accounts payable departments to operate more efficiently.

According to one aspect of the invention, a system for sharing tax-related information includes: a server including a processor and memory; a database accessible by the server, the database storing tax-related information corresponding to Form W-9; and logic stored in memory and executable by the processor, the logic configured to cause the processor to at least one of i) enable a user to add to the database tax-related information corresponding to Form W-9, ii) enable a user to access tax-related information stored in the database and corresponding to Form W-9, or iii) enable a user to change tax-related information stored in the database and corresponding to Form W-9.

According to one aspect of the invention, the system further includes logic configured to cause the processor to correlate tax-related information corresponding to Form W-9 with payees associated with a business entity.

According to one aspect of the invention, the system includes logic configured to cause the processor to grant a user access to the repository based on a pre-determined criterion.

According to one aspect of the invention, the predetermined criterion is membership to a predetermined group.

According to one aspect of the invention, the pre-determined group includes an employee of a business entity.

According to one aspect of the invention, the pre-determined group includes an employee within a department of a business entity.

According to one aspect of the invention, the logic configured to cause the processor to grant a user access to the repository based on a pre-determined criterion includes logic that grants access to a user upon the user paying a fee.

According to one aspect of the invention, the system includes logic that causes the processor to automatically generate information corresponding to Form 1099-MISC.

According to one aspect of the invention, a method of sharing tax-related information includes: establishing a repository for storing tax-related information corresponding to Form W-9; granting a user access to the repository based on a pre-determined criterion; upon the user accessing the repository, allowing the user to at least one of i) add to the repository tax-related information corresponding to Form W-9, ii) access tax-related information stored in the repository and corresponding to Form W-9, or iii) change tax-related information stored in the repository and corresponding to Form W-9.

According to one aspect of the invention, the method includes correlating the tax-related information corresponding to Form W-9 with payees associated with a business entity.

According to one aspect of the invention, granting the user access to the repository based on the pre-determined criterion includes granting the user access upon membership to a predetermined group.

According to one aspect of the invention, the pre-determined group includes an employee of a business entity.

According to one aspect of the invention, the pre-determined group includes an employee within a department of a business entity.

According to one aspect of the invention, the department includes at least one of an accounts payable department or an accounts receivable department.

According to one aspect of the invention, granting the user access to the repository based on the pre-determined criterion includes granting the user access upon the user paying a fee.

According to one aspect of the invention, granting the user access upon the user paying the fee includes the user paying a fee corresponding to a subscription service for accessing the repository.

According to one aspect of the invention, the method includes accessing the repository via a website.

According to one aspect of the invention, the method includes accessing the repository via a business management interface.

According to one aspect of the invention, the method includes identifying at least one record in the repository that is affiliated with a business entity, and retrieving the record.

According to one aspect of the invention, the method includes automatically generating information for reporting wages paid to payees of the business entity based on the retrieved record.

According to one aspect of the invention, the generated information corresponds to form 1099-MISC.

According to one aspect of the invention, the method includes certifying the accuracy of the tax-related information stored in the repository.

A number of features are described herein with respect to embodiments of the invention; it will be appreciated that features described with respect to a given embodiment also may be employed in connection with other embodiments.

For a better understanding of the present invention, together with other and further aspects thereof, reference is made to the following description, taken in conjunction with the accompanying drawings. The scope of the invention is set forth in the appended claims, which set forth in detail certain illustrative embodiments. These embodiments are indicative, however, of but a few of the various ways in which the principles of the invention may be employed.

### BRIEF DESCRIPTION OF THE DRAWINGS

FIG. 1 illustrates a conventional Form W-9 issued by the U.S. government.

FIG. 2 illustrates a conventional Form 1099-MISC issued by the U.S. government.

FIG. 3 is a schematic diagram of an exemplary system for storing, modifying and sharing tax-related information in accordance with the present invention.

FIG. 4 is a block diagram illustrating exemplary features of a server for storing, modifying and sharing tax-related information in accordance with the present invention.

FIG. 5 illustrates an exemplary user interface for storing, modifying and sharing tax-related information in accordance with the present invention.

FIG. 6 illustrates an exemplary database for storing, modifying and sharing tax-related information in accordance with the present invention.

FIG. 7 is a flow chart illustrating exemplary steps for performing a method in accordance with the present invention.

FIG. 8 is another flow chart illustrating exemplary steps for performing a method in accordance with the present invention.

### DETAILED DESCRIPTION OF THE INVENTION

The present invention is now described in detail with reference to the drawings. In the drawings, each element with a reference number is similar to other elements with the same reference number independent of any letter designation following the reference number.

It should be appreciated that many of the elements discussed in this specification may be implemented in a hardware circuit(s), a processor executing software code or instructions which are encoded within computer readable media accessible to the processor, or a combination of a hardware circuit(s) and a processor or control block of an integrated circuit executing machine readable code encoded within a computer readable media. As such, the term circuit, module, server, function, application, or other equivalent description of an element as used throughout this specification is, unless otherwise indicated, intended to encompass a hardware circuit (whether discrete elements or an integrated circuit block), a processor or control block executing code encoded in a computer readable media, or a combination of a hardware circuit(s) and a processor and/or control block executing such code.

The present invention will be described with respect to Form W-9 issued by the U.S. government. It is noted, however, that the present invention is not specific to Form W-9, but instead is applicable to any tax-related information corresponding to the identification of an individual or business entity for purposes of reporting income. Such information includes one or more of a name or a person or business entity, address of the person or business entity, or an identification number of the individual or business entity. As used herein, a legal person is defined as an individual, association, corporation, partnership, proprietorship, or trust that has legal standing in the eyes of the law. A business entity is defined as a legal person engaged in a business operation. A payee is defined as a legal person for whom a business entity is required to report income to the payee on Form 1099.

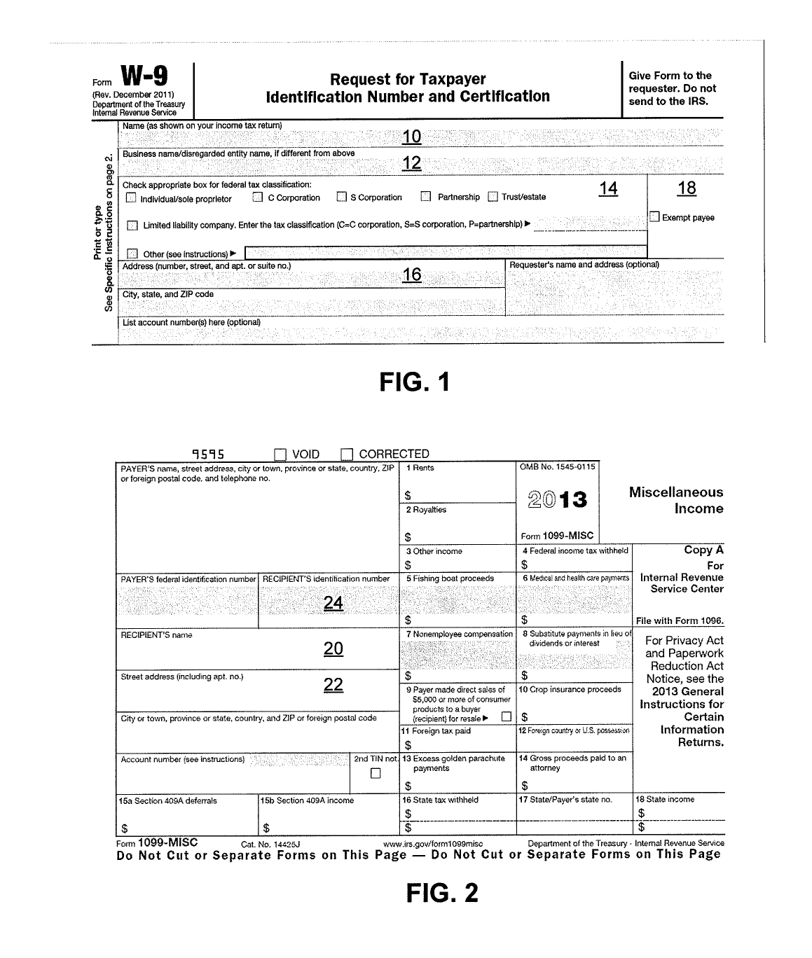

As was discussed above, a purpose of Form W-9 is to collect information for payees that received wages from a business entity (also referred to herein as a payer). Referring to FIG. 1, Form W-9, which is issued by the U.S. government, includes a name entry 10, a business name entry 12, a tax classification entry 14, an address entry 16, and an exempt payee entry 18. The information on Form W-9 is self-explanatory and well known by a person having ordinary skill in the art and therefore will not be discussed in detail herein. The information collected via Form W-9 is used to generate Form 1099-MISC, which reports the wages paid by the business entity to the payee. FIG. 2 illustrates Form 1099-MISC as issued by the U.S. Government.

Form 1099-MISC typically is processed by the business entity that paid wages to the payee, and also includes a number of entries. Of particular interest in Form 1099-MISC is the recipient's name 20, address 22, and recipient's identification number 24, as the information entered in the these boxes of Form 1099-MISC is collected via Form W-9. In preparing a report to the IRS, the business entity records the payee's information in Form 1099-MISC along with the wages paid to the worker/affiliate. A copy of Form 1099-MISC then is submitted to the IRS and to the payee.

In order to provide accurate information to the IRS, the business entity must ensure that the Form W-9 information collected from the payee is correct. However, due to circumstance beyond the business entity's control, the information may be inaccurate, thus possibly introducing errors in the report.

A system and method in accordance with the present invention reduces the chance of introducing errors when reporting to the IRS. In accordance with one aspect of the invention, the system and method in accordance with the present invention provide an electronic repository for storing tax-related information, such as information found on Form W-9. The tax-related information stored in the repository, which is also referred to as a “record” in the repository, may be shared among members within a group (e.g., employees of a company or employees within a specific department of the company) or between different groups (e.g., between employees of different companies). Access to the repository enables records to be created (e.g., uploading tax-related information to the repository), searched, modified (e.g., updating previously created information), and shared. By spreading the task of creating and modifying such tax-related information over different entities, the procurement of Form W-9 information can be streamlined.

For example, payees typically work for a number of different business entities in a given year. Business entities typically collect Form W-9 information from the payee prior to paying the payee. If a record of such information is uploaded and/or modified in the repository when it is acquired by a business entity, then the information is available to other business entities simply by searching the repository and downloading the latest record.

In addition to collecting, modifying and storing the information in the repository, in accordance with another aspect of the invention additional information, such as a time and date stamp, can be associated with each record. The time and date stamp can indicate when the record was last updated as well as who created and/or last modified the record. Such additional information, which is referred to as a flag, can assist in determining whether or not the information stored in the repository requires further investigation.

For example, if a record was recently updated as indicated by a flag associated with the record, then it can reasonably be concluded that the record is accurate and no further investigation is necessary. However, if the flag indicates the record has not been updated and/or verified for several years, then it may be prudent to further investigate the accuracy of the record. Upon verifying that the record is accurate or upon revising the record based on new information, the flag can be updated to show the time and date in which the record was last verified.

It is noted that flags other than a time and date stamp may be utilized based on the needs of the specific application. For example, flags also can be defined for alerting a business entity that certain records of interest have been updated in the repository. Such updates, for example, may trigger an automatic download of the updated record(s).

Additionally, the system may require certification to ensure records in the repository are accurate. For example, at predetermined intervals (e.g., yearly intervals) an email or the like may be sent to one or more company contacts, the email including a link to the repository. The company contact(s) then could access the repository via the link and confirm the accuracy of the records associated with the company. Alternatively, certification could be performed during a login process, e.g., when accessing the repository, the user confirms the accuracy of the records associated with the company. Such confirmation of the records may be required each time the user logs into the system or over a predetermined interval (e.g., quarterly, yearly, etc.). Preferably, the predetermined interval is set such that a confirmation occurs late in the calendar year, thereby facilitating accurate 1099 reporting in January.

In accordance with another aspect of the invention, records within the repository can be tagged to indicate an association between the record and a particular business entity. In this manner, the business entity can automatically identify records of interest in the repository and retrieve the respective records therefrom. Similarly, upon the business entity obtaining updated tax-related information for a particular payee, the tags can be used to automatically update the record stored in the repository.

In accordance with another aspect of the invention, the system and method can automatically generate 1099-MISC reports or the like. In this regard, records of interest can be tagged as being associated with a particular business entity. For example, if a business entity used ten different payees to perform certain tasks within a tax year, those payees can be tagged as being associated with the business entity. Upon preparing 1099-MISC reports for the IRS, the system and method in accordance with the present invention can automatically retrieve from the repository the Form W-9 information and populate Form 1099-MISC. The populated form then can be transferred to the business entity for further processing. Alternatively, the retrieved records can be downloaded to a workstation of the business entity and used to update their records. Form 1099-MISC then can be generated by the business entity based on the updated records. Such auto-generation of Form-1099 not only reduces the workload on employees of the business entity that is preparing the IRS report, but also minimizes the chance of introducing errors in the IRS report.

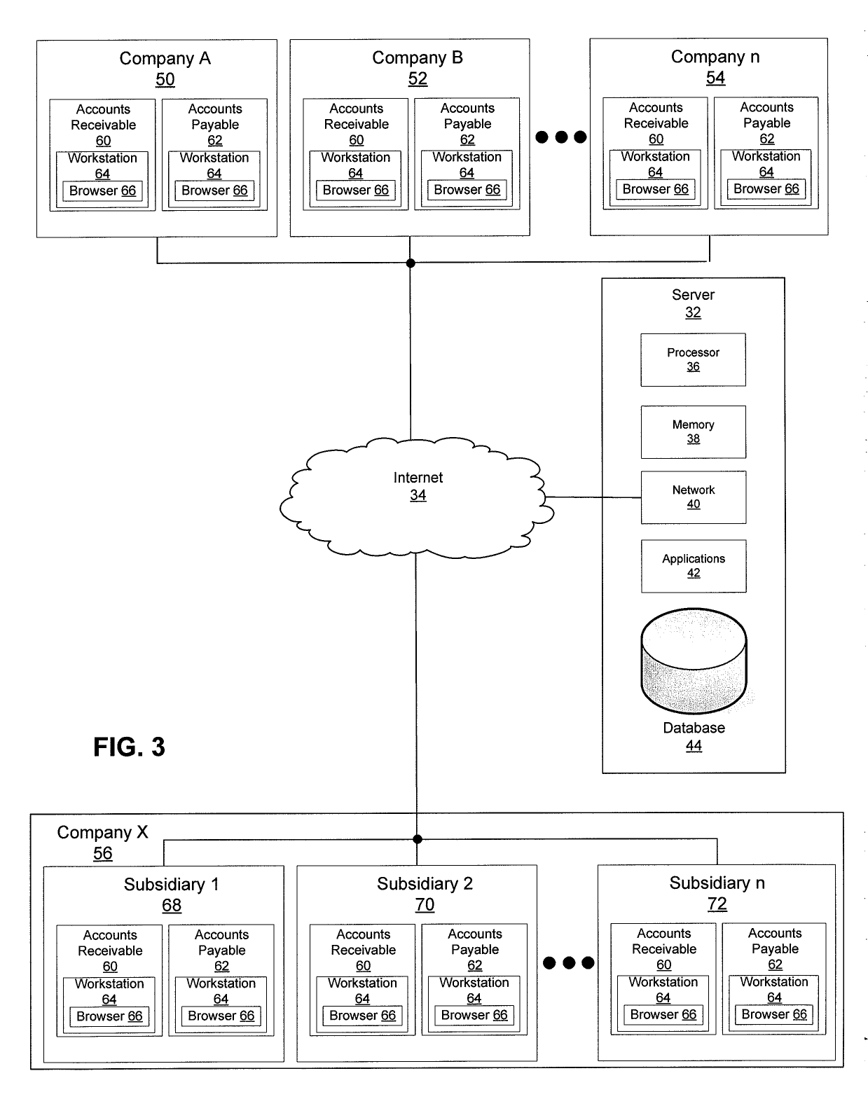

Referring now to FIG. 3, a system 30 is shown that enables tax-related information, such as that found on Form W-9, to be collected, updated and shared amongst various departments and/or business entities. In the system of FIG. 3, a server 32 is accessible, for example, via a network 34, which may include the internet. The server 32 includes a processor 36 and memory 38 for executing instructions stored in memory 38. The memory 38 may include both volatile and non-volatile memory as is conventional. A network interface 40, such as an Ethernet interface or the like, communicatively couples the server 32 to other computers via the network 34.

The server 32 also includes a number of applications 42, which, for example, may be stored in memory 38 and executable by the processor 36. The functionality of the specific applications will be discussed in more detail below. While the applications 42 are embodied as software applications, the functionality carried out by such applications could be implemented by hardware or a combination of hardware and software.

The server 32 further includes or has access to a database 44. As will be described in more detail below, the database 44 is operative to store tax-related information that can be shared among a number of different entities.

Various entities, such as companies 50, 52, 54 and 56 can access the database 44 to add, modify and/or retrieve information stored therein. Further, each company may have multiple departments, e.g., an accounts receivable department 60 and an accounts payable department 62, where employees who work in the accounts receivable department 60 may be considered to be part of a first group and employees who work in the accounts payable department 62 may be considered to be part of a second group. As discussed in more detail below, membership to a particular group may have certain database privileges associated therewith.

To communicate with the server 32, employees within each department may have access to a workstation 64 or the like. Preferably, the workstation includes a user interface 66 that enables information stored in the database 44 to be viewed and manipulated. In one embodiment the interface 66 is an internet browser interface or the like that can access a web page. In another embodiment, the interface is part of a business management system.

In addition to the entities being separate and distinct from one another, e.g., Company A is separate and distinct from Company B, etc., the entities may have some relation to one another. For example, Company D has a plurality of subsidiaries 68, 70, and 72. Each subsidiary 68, 70, and 72, while being business entities, are related to one another by being completely or partly owned and partly or wholly controlled by another company, namely Company D. In such scenario, employees of Subsidiary 1 may be considered to belong to a first group, employees of Subsidiary 2 may be considered to belong to a second group, and employees of Subsidiary n may be considered to belong to a third group, where the first, second and third groups may or may not share common privileges.

Subgroups may also be formed within a respective group. For example, the accounts receivable group 60 and the accounts payable group 62 of Subsidiary 1 may be considered sub-groups of the first group (i.e., a sub-group of Subsidiary 1). As noted above and discussed in more detail below, group membership can determine who may share information, view information and modify information.

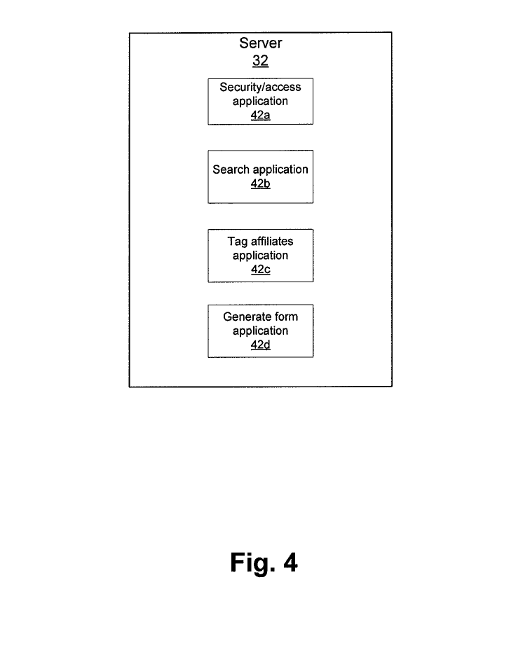

With further reference to FIG. 4, applications 42a-42f included in the server 32 are shown. The applications include a security application 42a, a search application 42b, a tag application 42c and a generate form application 42d.

The security application 42a operates to determine if a user may access the database 44. In this regard, a user may be provided with a username and password for logging into the server as is conventional. The means by which the username and password may be obtained can vary depending on the specifics of the system. In one embodiment a username may be obtained by paying a fee for accessing the system (e.g., a subscription-based service). In another embodiment, a username may be created by a system administrator based on membership to a particular group (e.g., an employee within a particular department of a company).

Upon the user entering his username and password, the security application 42a verifies that the password corresponds to the username as is conventional. Assuming the password corresponds to the username, the security application 42a then grants access to the database 44. As will appreciated, the criteria by which the security application 42a grants or denies access can be application specific. In one embodiment, the security application 42a grants or denies access based on a subscription status. For example, the security application 42a may check if the subscription fees for the latest subscription period have been paid. If the subscription service is inactive (i.e., the fee has not been paid) then access is denied, while if the subscription service is active (i.e., the fee has been paid) access is granted. In another embodiment, access may be based on employment status with a particular business entity. For example, if an individual is employed by a particular business entity, then access may be granted, while if the individual is no longer employed with the particular business entity then access may be denied.

Once the user has successfully logged into the system, the security application 42a may also attach privileges to the username. More particularly, each username may have associated therewith an access level that can be used to grant/restrict access to specific features. For example, a first level can be established that permits searching, viewing and downloading of information, and a second level can be established that, in addition to the features of the first level, further permits modification of information (e.g., creation, modification, and deletion of records). As will be appreciated, the specific access levels can be tailored to the specific needs of the user. Upon attaching an access level with the username, the user then is permitted to access the database 44 in accordance with the privileges associated with the access level.

Moving now to the search application 42b, this application operates to enable a user to search the database 44 for records that match specific criteria. The criteria can include, for example, the individual or business name, address and/or identification number. In addition, a search can be performed for specific affiliations between a record and a business entity. For example, a business entity may wish to retrieve records for individuals that had a business relationship with the business entity for a specific tax year. The search application 42b can retrieve such records based on tags associated with certain records in the database 44.

Tagging of records is implemented by the tag application 42c. More specifically, the tag application 42c enables one or more records stored in the database 44 to be marked as having a specific characteristic, e.g., the record is associated with a particular business entity. This can be advantageous, for example, if a business entity wishes to identity all records corresponding to payees that had a business relationship with the business entity for a particular tax year.

In order to retrieve records associated with a particular tag, such as a business entity, the records first need be tagged. Tagging of records preferably is performed at the time the record is created in the database. However, records may be tagged at any time including, for example, when the record is updated, viewed, downloaded, etc. The tag associated with a record can be in the form of a name, identification number, symbol or other means of identification. Once records are tagged, records associated with that tag can be easily retrieved by simply searching for the tag in the database.

As noted above another feature of the system and method in accordance with the present invention is the ability to generate or populate forms for reporting to the IRS. The generate forms application 44d can automatically generate specific forms, such as Form 1099-MISC and/or provide information for generating such forms to the business entity. While the generate forms application 42d is described in the context of generating Form 1099-MISC, this is merely exemplary and the generate forms application 42d can be configured to generate any desired form or provide specific information for a form based on the needs of the specific application. Further, while the system and method in accordance with the invention are described in the context of a standalone module, the system and method could be combined with other modules. For example, the system and method could be operated in conjunction with a payment module. In this regard, the payee information could be retrieved from the repository while the amount paid to the payee could be retrieved from the payment module. The combined information then could be used to populate form 1099-MISC. In this manner, the 1099 reporting process (or other process) can be streamlined.

In order to generate a form, the data used to populate the form is first identified. In one embodiment, the data may be automatically identified based on tags, e.g., a user may simply press a “generate forms” button and the system automatically retrieves the data based on a tag corresponding to the business entity. The retrieved data then is used, for example, to populate Form 1099-MISC. The populated form then can be transferred to the business entity, where additional information may be added to the form (e.g., wage information, etc.). Alternatively, the retrieved data can simply be transferred to the business entity, which then populates Form 1099-MISC based on the transferred data.

In another embodiment, the data used to populate the form is manually selected. For example, a user may search for specific records in the database and attach a specific tag to the specific records. Once selection is complete, the user can instruct the system to generate a form based on the tagged data or transfer the tagged data to the user's system.

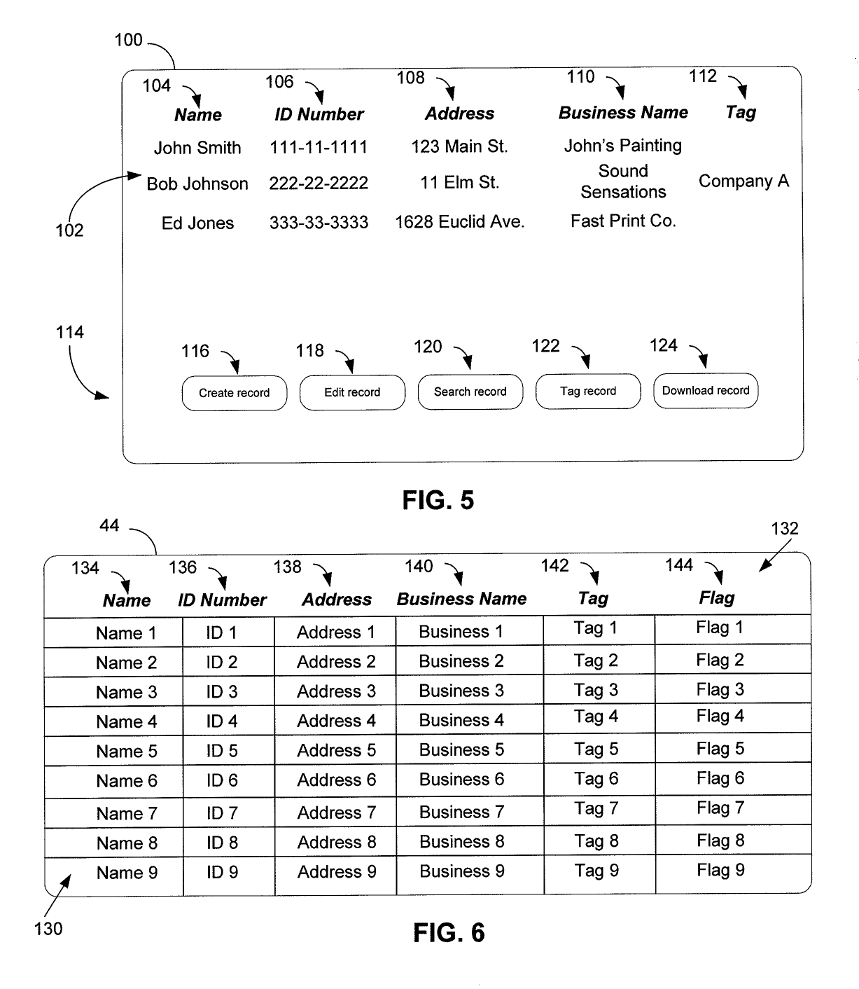

With further reference to FIG. 5, an exemplary interface 100 is illustrated that may be used with the system and method in accordance with the present invention. The exemplary interface 100 may be displayed, for example, on a display device of the workstation 64 using browser 66.

The user interface 100 includes an information display area 102 for displaying records stored in the database 44. Preferably, the display area 102 displays information corresponding to the information of interest. In the exemplary interface of FIG. 5, the information of interest is information identified in form W-9, such as a name entry 104, an identification number entry 106, an address entry 108 and a business name entry 110. Further, a tag entry 112 is also provided for indicating which tags are associated with a particular entry. A bottom portion of the interface 100 includes a function key area 114 that has a number of function keys, including a create record key 116, edit record key 118, search record key 120, tag record key 122, and download record key 124.

Moving now to FIG. 6, the structure of an exemplary database 44 that may be used in accordance with the present invention is illustrated. Preferably, the database 44 includes sufficient information to place each business entity using the database to generate Form 1099s in a “safe harbor”, i.e., to release the business entity from any potential inaccuracies in Form 1099s that were generated from the data stored in the database 44. The database 44 includes a number of rows 130 and columns 132, the intersection of a row and column defining a specific field. In the exemplary database 44 of FIG. 6, each row represents data corresponding to a particular Form W-9 (or like information), e.g., Form W-9 information for a specific payee, while each column corresponds to an entry box on Form W-9 (or like information).

The columns 132 include a name column 134, which corresponds to a name of the payee, and an ID number column 136, which corresponds to a specific identification number of the payee (e.g., social security number) or of the payee's business (e.g., the business' tax ID number). In addition, an address column 138 corresponds to an address of the payee or payee's business, and a business name column 140 corresponds to a name of the payee's business. The database 44 can further include a tag column 142 for storing user-created tags, and a flag column 144 for storing flags associated with each record, e.g., time stamps, etc. as described herein. Although not shown, the database 44 may include plural tag and/or flag columns to enable multiple tags and/or flags to be stored for each entry. Further, additional columns could be added based on needs of the specific application.

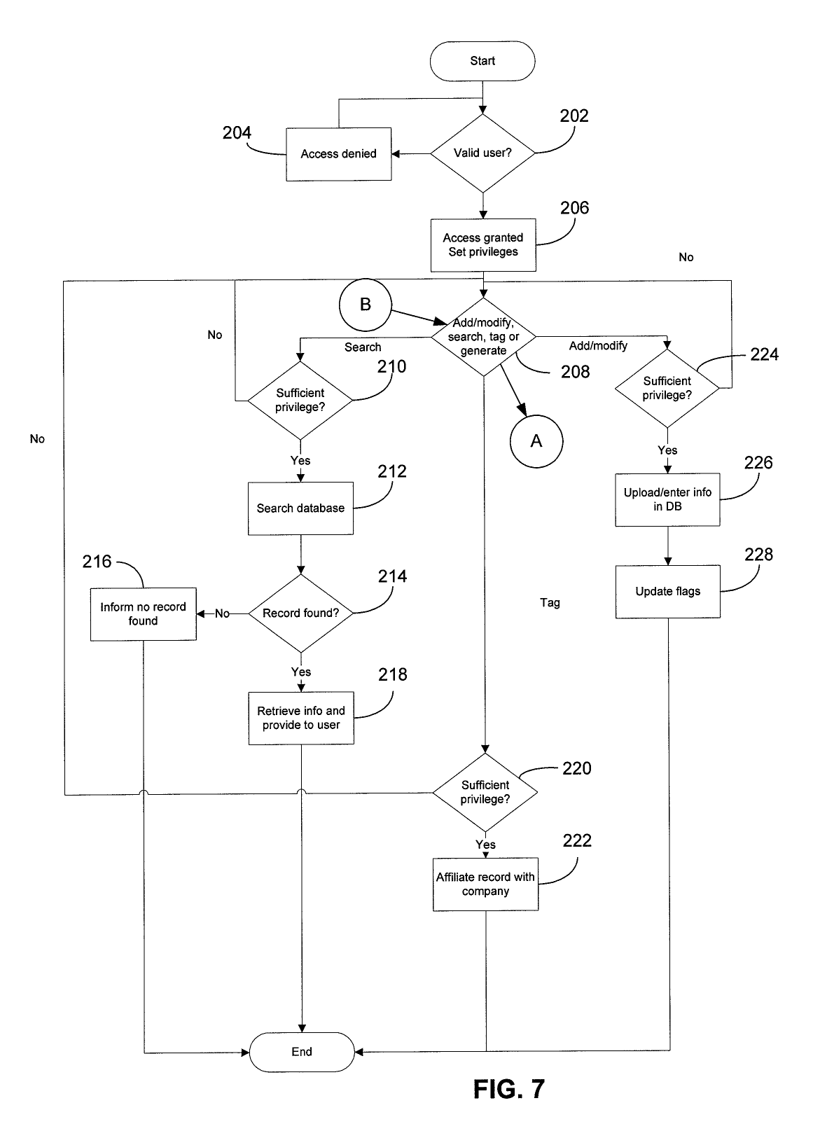

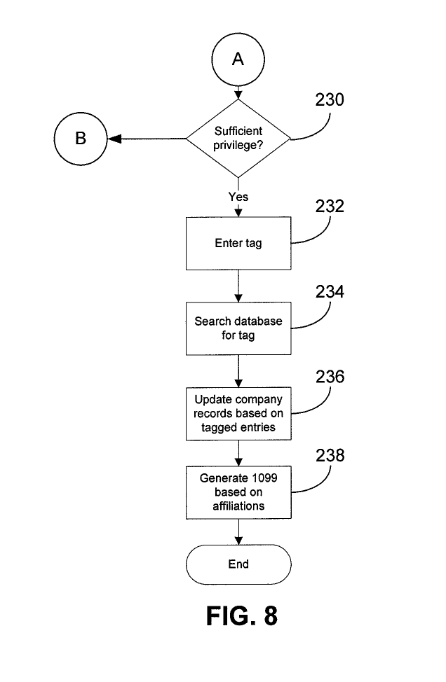

Moving to FIGS. 7 and 8, illustrated are logical operations to implement an exemplary method for assembling information contained within a financial instrument for subsequent verification of the financial instrument. The exemplary method may be carried out by executing an embodiment of one or more of the security application 42a, the search application 42b, the tag application 42c and the generate form application 42d, for example. Thus, the flow chart of FIGS. 7 and 8 may be thought of as depicting steps of a method carried out by the system in accordance with the invention.

Although FIGS. 7 and 8 show a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

Referring to FIG. 7, at block 202 it is determined if a user can access the database 44. For example, if the system 30 is a subscription-based service, then a user may be given an account upon initially subscribing to the service (e.g., upon paying the subscription fee). Each time the user attempts to use the account to access the database 44 the system may check if the subscription fees for the latest subscription period have been paid. If the fees have been paid then access may be granted and if not then access may be denied.

In a non-subscription-based system a user may be given an account by a system administrator based on predetermined criteria (e.g., employment with the business entity). Each time the user attempts to use the account to access the database 44 the system checks if the account is valid. The validity of the account may be based on any number of criteria, such as employment with a specific business entity, association with a specific department of a business entity, etc. Thus, for example, an employee who is a member of the accounts receivable department 60 of Company D may be deemed a valid account and thus granted access. If, at some later time, the employee is transferred to a different department within Company D and is no longer associated with the accounts receivable department 60, then even though the employee is still employed by Company D the account may be deemed invalid as it is not associated with the accounts receivable department, and any attempt to access the database 44 using the account may be denied.

If the account is determined to be invalid then at block 204 access is denied, while if the account is determined to be valid then at block 206 access is granted and privileges are attached to the account. The privileges, which may be based on an association with an employer, membership to a group, etc., can grant or restrict access to certain features of the system as discussed in more detail below.

After access is granted, at block 208 it is determined which operation the user wishes to perform. For example, the user may add a new record, modify an existing record, search all records, tag records or generate forms. If the user wishes to search the database 44 for specific records, then at block 210 the user's privileges are checked to determine if such operation may be performed. Preferably, all accounts have sufficient privilege to search the database 44. However, in certain circumstances it may be desirable to restrict a user's ability to search the database 44.

If the user does not have sufficient privilege to search the database, then the method moves back to block 208. However, if the user does have sufficient privilege to search the database 44, then at block 212 a search of the database 44 is performed using search criteria specified by the user. Such search criteria may be entered via the user interface 50, and may include tags, names, numbers, symbols, etc.

At block 214, it is determined if any records in the database 44 match the search criteria specified by the user, and if not then at block 216 the user is informed that no records were found. However, if records were found that match the search criteria, then at block 218 the search results are provided to the user. Providing the search results to the user may include, for example, displaying the results on a user interface as shown in FIG. 5. Additionally or alternatively, providing the search results to the user may include transferring the record(s) from the server 32 to the workstation 64.

Moving back to block 208, if the user wishes to tag records in the database, then at block 220 it is determined if the user has sufficient privilege to tag records. If the user does not have sufficient privilege, then the method moves back to block 208. If the user does have sufficient privilege then at block 222 the user may assign one or more tags to one or more records. The tags can correspond to the business entity so as to correlate tax information stored in the repository with affiliates of the business entity, thereby enabling certain records to be easily retrieved from the database 44. Additionally or alternatively, the tags can correspond to other associations, e.g., a year in which wages were associated with the record, or any other association that may be useful to the business entity. Regardless of the significance of each tag, the tags may be stored in the database 44 so as to be associated with the particular record. Further, each record may have multiple tags from multiple business entities associated therewith.

Moving back to block 208, if the user wishes to add a record or modify an existing record, then at block 224 it is determined if the user has sufficient privilege to add or modify records. If the user does not have sufficient privilege, then the method moves back to block 208. If the user does have sufficient privilege then at block 226 the user may enter a new record into the database 44. Entry of a new record may be performed, for example, by uploading a file containing the record information to the server, or manually entering the information via a user input device, e.g., a keyboard. With respect to editing an existing record, the user may specify the record that is to be modified, e.g., by entering a name, identification number or other searchable field for the record, and then changing one or more fields of the record via the user input device.

Once a record has been created or modified, then at block 228 flags associated with the record can be updated. For example, a time and date stamp may be associated with the record to indicate when the record was created or last modified. In addition, an identification stamp may be associated with the record to indicate who created or last modified the record. Such information can be useful, for example, when a question arises with respect to the accuracy of the record.

Moving back to block 208, if the user wishes to generate forms then the method moves to block 230, which is shown in FIG. 8. At block 230, it is determined if the user has sufficient privilege to generate forms. If the user does not have sufficient privilege, then the method moves back to block 208. If the user does have sufficient privilege then at block 232 the user may enter a tag that, for example, corresponds to the business entity for which the forms will be generated. The system then searches the database 44 for records that correspond to the entered tag as indicated at block 234. Next at block 238 the records corresponding to the tag are provided to the business entity, which then updates its internal records. Next at block 240 the form is generated based on the updated records.

Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

1. A system for sharing tax-related information, comprising:
a server including a processor and memory;
a database accessible by the server, the database storing tax-related information corresponding to Form W-9;
logic stored in memory and executable by the processor, the logic including
logic configured to cause the processor to at least one of i) enable a user to add to the database payee tax-related information corresponding to Form W-9, ii) enable a user to access payee tax-related information stored in the database and corresponding to Form W-9, or iii) enable a user to change payee tax-related information stored in the database and corresponding to Form W-9; and
logic configured to share the payee tax-related information stored in the database between a first business entity and a second business entity both different from the payee, the first business entity separate and distinct from the second business entity.

2. The system according to claim 1, further comprising logic configured to cause the processor to correlate tax-related information corresponding to Form W-9 with payees associated with a business entity.

3. The system according to claim 1, further comprising logic configured to cause the processor to grant a user access to the repository based on a pre-determined criterion.

4. The system according to claim 3, wherein the predetermined criterion is membership to a predetermined group.

5. The system according to claim 4, wherein the pre-determined group comprises an employee of a business entity.

6. The system according to claim 4, wherein the pre-determined group comprises an employee within a department of a business entity.

7. The system according to claim 1, wherein the logic configured to cause the processor to grant a user access to the repository based on a pre-determined criterion includes logic that grants access to a user upon the user paying a fee.

8. The system according to claim 1, further comprising logic that causes the processor to automatically generate information corresponding to Form 1099-MISC.
a server including a processor and memory;
a database accessible by the server, the database storing tax-related information corresponding to Form W-9

9. A method of sharing tax-related information, comprising:
establishing an electronic repository for storing tax-related information corresponding to Form W-9;
granting a user access to the electronic repository based on a pre-determined criterion;
upon the user accessing the electronic repository, allowing the user to at least one of i) add to the electronic repository payee tax-related information corresponding to Form W-9, ii) access payee tax-related information stored in the electronic repository and corresponding to Form W-9, or iii) change payee tax-related information stored in the electronic repository and corresponding to Form W-9; and
sharing the payee tax-related information stored in the electronic repository between a first business entity and a second business entity both different from the payee, the first business entity separate and distinct from the second business entity.

10. The method according to claim 9, further comprising correlating the tax-related information corresponding to Form W-9 with payees associated with a business entity.

11. The method according to claim 9, wherein granting the user access to the repository based on the pre-determined criterion includes granting the user access upon membership to a predetermined group.

12. The method according to claim 11, wherein the pre-determined group comprises an employee of a business entity.

13. The method according to claim 11, wherein the pre-determined group comprises an employee within a department of a business entity.

14. The method according to claim 13, wherein the department comprises at least one of an accounts payable department or an accounts receivable department.

15. The method according to claim 9, wherein granting the user access to the repository based on the pre-determined criterion includes granting the user access upon the user paying a fee.

16. The method according to claim 15, wherein granting the user access upon the user paying the fee includes the user paying a fee corresponding to a subscription service for accessing the repository.

17. The method according to claim 9, further comprising accessing the repository via a website.

18. The method according to claim 9, further comprising accessing the repository via a business management interface.

19. The method according to claim 9, further comprising identifying at least one record in the repository that is affiliated with a business entity, and retrieving the record.

20. The method according to claim 19, further comprising automatically generating information for reporting wages paid to payees of the business entity based on the retrieved record.

21. The method according to claim 20, wherein the information corresponds to form 1099-MISC.

22. The method according to claim 9, further comprising certifying the accuracy of the tax-related information stored in the repository.
